(19) United States
(12) Patent Application Publication
(10) Pub. No.: US 2025/0385280 A1
(43) Pub. Date: Dec. 18, 2025

(54) SEPARATOR ASSEMBLY TO PREVENT CORROSION OF SEPARATOR EDGE AND FUEL CELL STACK INCLUDING THE SAME

(71) Applicants: HYUNDAI MOTOR COMPANY, SEOUL (KR); KIA CORPORATION, SEOUL (KR)

(72) Inventor: Jong Hyeok Noh, Hwaseong-si (KR)

(73) Assignees: HYUNDAI MOTOR COMPANY, SEOUL (KR); KIA CORPORATION, SEOUL (KR)

(21) Appl. No.: 18/888,448

(22) Filed: Sep. 18, 2024

(30) Foreign Application Priority Data
Jun. 17, 2024 (KR) 10-2024-0077999

(51) Int. Cl. H01M 8/0276; H01M 8/0247; H01M 8/0267; H01M 8/2483

(52) U.S. Cl. CPC H01M 8/0276; H01M 8/0247; H01M 8/0267; H01M 8/2483

(57) ABSTRACT

A separator assembly to prevent corrosion of a separator edge may include a first separator and a second separator having at least one manifold through which reactive gas or cooling water flows, wherein the first separator has a first surface and a second surface, and the second separator has a third surface and a fourth surface, wherein the first surface of the first separator has arranged thereon a first gasket, and wherein the first gasket connects the first surface to the fourth surface to surround an edge of the first separator and an edge of the second separator exposed by the least one manifold.

### CROSS REFERENCE TO RELATED APPLICATIONS

The present application claims priority to Korean Patent Application No. 10-2024-0077999, filed on Jun. 17, 2024, the entire contents of which is incorporated herein for all purposes by this reference.

### TECHNICAL FIELD

The present disclosure relates to a separator assembly, including a gasket arranged to cover a separator edge to prevent corrosion of the separator edge, and a fuel cell stack including the separator assembly.

### BACKGROUND

A fuel cell is a type of power generator that converts the chemical energy of a fuel into electric energy through an electrochemical reaction in a stack, produces electric power for small electronic devices such as portable devices as well as produces driving power for industrial use, household use, and vehicles. In recent years, the use of the fuel cell has been gradually increasing as a highly efficient and clean energy source. Within a general fuel cell stack, a membrane-electrode assembly (MEA) is arranged at the innermost portion thereof, and the MEA includes a polymer electrolyte membrane, capable of transporting hydrogen ions (protons), and catalyst layers (i.e., an anode and a cathode) stacked on opposite surfaces of the electrolyte membrane to allow hydrogen and oxygen to react to each other. A gas diffusion layer (GDL) is stacked on the MEA, and a pair of separators in which flow fields are formed to supply fuel and discharge water produced by a reaction is stacked on the external side of the GDL. An end plate for supporting and fixing the components constituting the fuel cell stack is coupled to the external side of the GDL on which the separators are stacked.

Separators are generally made of metal, graphite, or composite materials, and mainly made of metal for reasons of weight, price, ease of production, mass production, etc. In a metal separator, metal is composed of elements such as manganese (Mn), iron (F), chromium (Cr), titanium (Ti), nickel (Ni), etc., and when these metal elements corrode and dissolve in the fuel cell where an electrochemical reaction occurs, they get to deteriorate the MEA. For this reason, the corrosion resistance on the surface of the separator is strengthened by adopting a material with high corrosion resistance, such as titanium (Ti), or through a surface modification, coating, etc.

In a fuel cell stack manufacturing process, a trimming process to cut out a portion of the separator is performed so as to create a manifold through which reactive gas or cooling water flows. Referring to FIG. 1 and FIG. 2, a gasket structure 30 is arranged on separators 10 and 20 to seal around a manifold 5. Guide portions (not shown) configured to distribute reactive gas or cooling water flowing from the manifold 5 to a reactive area or from the reactive area to the manifold 5 are provided between the separators 10 and 20. The guide portions are included in the gasket structure 30 but are not shown in FIG. 2 because FIG. 2 is a cross-sectional view where a space between the guide portions adjacent to each other is cut.

In FIG. 2, edges A of the separators 10 and 20 are exposed due to the trimming process to create the manifold 5, but other edges other than the edges A of the separators 10 and 20 have gone through a surface modification and coating to strengthen corrosion resistance. However, the edges A of the separators 10 and 20 exposed due to the trimming process have a problem of being vulnerable to corrosion because the edges A are exposed without a surface modification or coating to strengthen corrosion resistance.

The information included in this Background of the present disclosure is only for enhancement of understanding of the general background of the present disclosure and may not be taken as an acknowledgement or any form of suggestion that this information forms the prior art already known to a person skilled in the art.

### SUMMARY

The present disclosure has been made in an effort to solve the above-described problems associated with the prior art, and an object of the present disclosure is to provide a separator assembly, including a gasket arranged to cover a separator edge to prevent corrosion of the separator edge, and a fuel cell stack including the separator assembly.

Another object of the present disclosure is to provide a separator assembly, including a gasket having a structure capable of strengthening the coupling force between two separators adjacent to each other while preventing corrosion of the edges of the separators, and a fuel cell stack including the separator assembly.

In one aspect, the present disclosure provides a separator assembly to prevent corrosion of a separator edge. In a separator assembly to prevent corrosion of a separator edge, the separator assembly includes a first separator and a second separator having at least one manifold through which reactive gas or cooling water flows. Here, the first separator may have a first surface and a second surface and the second separator may have a third surface and a fourth surface, a first gasket may be arranged on the first surface of the first separator, and the first gasket may connect the first surface to the fourth surface to surround an edge of the first separator and an edge of the second separator exposed by the least one manifold.

In an exemplary embodiment of the present disclosure, the second surface and the third surface may be arranged to face each other, and the first gasket may include a slit configured to allow reactive gas or cooling water to flow between the second surface and the third surface or to discharge reactive gas or cooling water between the second surface and the third surface

In another exemplary embodiment of the present disclosure, on the third surface of the second separator, a second gasket may be arranged along a perimeter of the at least one manifold, and the second gasket may have an open area at one side thereof to allow reactive gas or cooling water to flow to the at least one manifold.

In yet another exemplary embodiment of the present disclosure, the second gasket may include guide portions arranged at the open area and configured to distribute reactive gas or cooling water.

In yet another exemplary embodiment of the present disclosure, the guide portions may have an open space therebetween that aligns with the slit.

In still yet another exemplary embodiment of the present disclosure, on the third surface of the second separator, a second gasket may be arranged along a perimeter of the at least one manifold, and the second gasket may include at least one protrusion protruding toward the at least one manifold and guide portions configured to distribute reactive gas or cooling water.

In a further exemplary embodiment of the present disclosure, the at least one protrusion and the guide portions each may have one end protruding toward the at least one manifold in a direction perpendicular to a direction in which the first separator and the second separator are stacked.

In another further exemplary embodiment of the present disclosure, the first gasket may include through holes, and the one end of each of the at least one protrusion and the guide portions may be inserted into a corresponding one of the through holes.

In yet another further exemplary embodiment of the present disclosure, the first gasket may include a slit, configured to flow therethrough reactive gas or cooling water and provided between the through holes into each of which one end of the guide portion is inserted.

In yet another further exemplary embodiment of the present disclosure, the first gasket may be arranged along a perimeter of the at least one manifold on the first surface of the first separator and on the fourth surface of the second separator.

In still yet another further exemplary embodiment of the present disclosure, the first gasket may be arranged to come into contact with all of the first surface, the fourth surface, the edge of the first separator, and the edge of the second separator.

In a still further exemplary embodiment of the present disclosure, an edge of one end of the first gasket arranged on the fourth surface of the second separator may be chamfered.

In still another further exemplary embodiment of the present disclosure, on the third surface of the second separator, a second gasket may be arranged along a perimeter of the at least one manifold, and on the fourth surface of the second separator, a third gasket may be arranged along a perimeter of the at least one manifold. The first gasket may include one end arranged on the fourth surface and another end arranged at a position overlapping the third gasket with respect to a stacking direction from the first separator to the second separator.

In a yet still further exemplary embodiment of the present disclosure, a portion of the first gasket connecting the one end to the other end may surround the edge of the first separator and the edge of the second separator.

In another aspect, the present disclosure provides a fuel cell stack including first separators, second separators, and a gasket structure arranged on the first separators and the second separators. Here, the first separators and the second separators may have at least one first manifold and at least one second manifold through which reactive gas or cooling water flows, and the gasket structure may include a first gasket structure surrounding edges of the first separator and the second separator exposed by the at least one first manifold, and a second gasket structure surrounding edges of the first separator and the second separator exposed by the at least one second manifold.

In an exemplary embodiment of the present disclosure, a flow direction of reactive gas or cooling water flowing through the at least one first manifold and a flow direction of reactive gas or cooling water flowing through the at least one second manifold may be different from each other.

In another exemplary embodiment of the present disclosure, the first gasket structure and the second gasket structure both may be in contact with the second separator, and any one separator of the first separators in contact with the first gasket structure and the other one separator of the first separators in contact with the second gasket structure may be different from each other.

In yet another exemplary embodiment of the present disclosure, the first gasket structure may have one end arranged to overlap a third gasket structure arranged on the any one separator and another end facing the one end, the one end of the first gasket structure may be arranged on the second separator and the other end of the first gasket structure may be arranged on the any one separator, and a flow direction of reactive gas or cooling water flowing through the at least one first manifold may be a direction from one surface of the second separator in contact with the one end of the first gasket structure toward one surface of the any one separator in contact with the other end of the first gasket structure.

In yet another exemplary embodiment of the present disclosure, the second gasket structure may have one end arranged to overlap a fourth gasket structure arranged on the other one separator and another end facing the one end, the one end of the second gasket structure may be arranged on the second separator and the other end of the second gasket structure is arranged on the other one separator, and a flow direction of reactive gas or cooling water flowing through the at least one second manifold may be a direction from one surface of the second separator in contact with the one end of the second gasket structure toward one surface of the other one separator in contact with the other end of the second gasket structure.

In still yet another exemplary embodiment of the present disclosure, the first gasket structure may include a first slit configured to allow reactive gas or cooling water to flow through the at least one first manifold and through a space between the second separator and the any one separator, and the second gasket structure may include a second slit configured to allow reactive gas or cooling water to flow through the at least one first manifold and through a space between the second separator and the other one separator.

Other aspects and exemplary embodiments of the present disclosure are discussed infra.

It is to be understood that the term “vehicle” or “vehicular” or other similar terms as used herein are inclusive of motor vehicles in general, such as passenger vehicles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE FIGURES

FIG. 1 is a view illustrating a general separator assembly;

FIG. 2 is a cross-sectional view taken along line X-X′ in FIG. 1;

FIG. 3 is a view illustrating a separator according to an exemplary embodiment of the present disclosure;

FIG. 4 is a view illustrating a separator assembly according to one exemplary embodiment of the present disclosure;

FIG. 5 is a view illustrating a first surface of a first separator according to one exemplary embodiment of the present disclosure;

FIG. 6 is a view illustrating a second surface of a first separator according to one exemplary embodiment of the present disclosure;

FIG. 7 is a view illustrating a third surface of a second separator according to one exemplary embodiment of the present disclosure;

FIG. 8 is a view illustrating a fourth surface of a second separator according to one exemplary embodiment of the present disclosure;

FIG. 9 is a cross-sectional view taken along line A-A′ in FIG. 4;

FIG. 10 is a cross-sectional view taken along line B-B′ in FIG. 4;

FIG. 11 is a view illustrating a separator assembly according to a different exemplary embodiment of the present disclosure;

FIG. 12 is a view illustrating a first surface of a first separator according to a different exemplary embodiment of the present disclosure;

FIG. 13 is a view illustrating a second surface of a first separator according to a different exemplary embodiment of the present disclosure;

FIG. 14 is a view illustrating a third surface of a second separator according to a different exemplary embodiment of the present disclosure;

FIG. 15 is a view illustrating a fourth surface of a second separator according to a different exemplary embodiment of the present disclosure;

FIG. 16 is a cross-sectional view taken along line C-C′ in FIG. 11;

FIG. 17 is a cross-sectional view taken along line D-D′ in FIG. 11;

FIG. 18 is a cross-sectional view of a separator assembly according to a further different exemplary embodiment of the present disclosure;

FIG. 19 is a cross-sectional view illustrating the direction in which a first gasket of a separator assembly is arranged with respect to the fluid movement direction according to the present disclosure;

FIG. 20 is a view illustrating a fuel cell stack according to an exemplary embodiment of the present disclosure; and

FIG. 21 is a cross-sectional view taken along line E-E′ in FIG. 20.

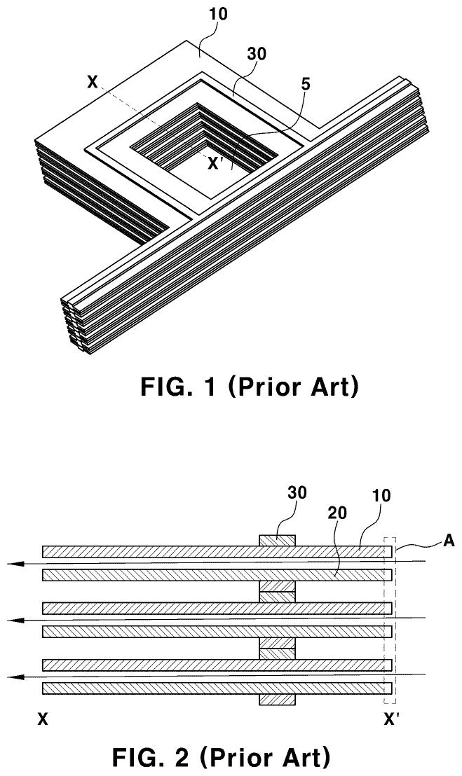

It should be understood that the appended drawings are not necessarily to scale, presenting a somewhat simplified representation of various exemplary features illustrative of the basic principles of the present disclosure. The predetermined design features of the present disclosure, including, for example, predetermined dimensions, orientations, locations, and shapes, will be determined in part by the particular intended application and usage environment.

In the figures, the reference numerals refer to the same or equivalent portions of the present disclosure throughout the several figures of the drawing.

### DETAILED DESCRIPTION

Hereinafter reference will now be made in detail to various embodiments of the present disclosure, examples of which are illustrated in the accompanying drawings and described below. However, the present disclosure may be embodied in various forms, and should not be construed as being limited to the exemplary embodiments set forth herein. Rather, the exemplary embodiments are provided so that the present disclosure will be thorough and complete, and will fully convey the scope of the present disclosure to those skilled in the art. The present disclosure is defined only by the categories of the claims. Wherever possible, the same reference numerals will be used throughout the drawings to refer to the same or like portions.

Terms such as “ . . . portion”, “ . . . unit”, “ . . . module”, etc. used in the present specification each refer to a unit that processes at least one function or operation, and may be implemented as hardware, software or a combination thereof.

It will be understood that, although the terms “first”, “second”, etc. may be used herein to describe various similar elements, these elements should not be construed as being limited by these terms. These terms are only used to distinguish one element from another.

The detailed description is merely illustrative of the present disclosure. Furthermore, the above description shows and describes exemplary embodiments of the present disclosure, but the present disclosure may be used in various other combinations, modifications, and environments. In other words, changes or modifications are possible within the scope of the idea of the present disclosure included herein, the scope equivalent to the described invention, and/or the scope of skill or knowledge in the art. The exemplary embodiments describe the best state for implementing the technical idea of the present disclosure, and various changes required for specific application fields and utilizes of the present disclosure are possible. Therefore, the detailed description of the present disclosure is not intended to limit the present disclosure to the disclosed exemplary embodiments of the present disclosure. Also, the appended claims should be construed to include other embodiments.

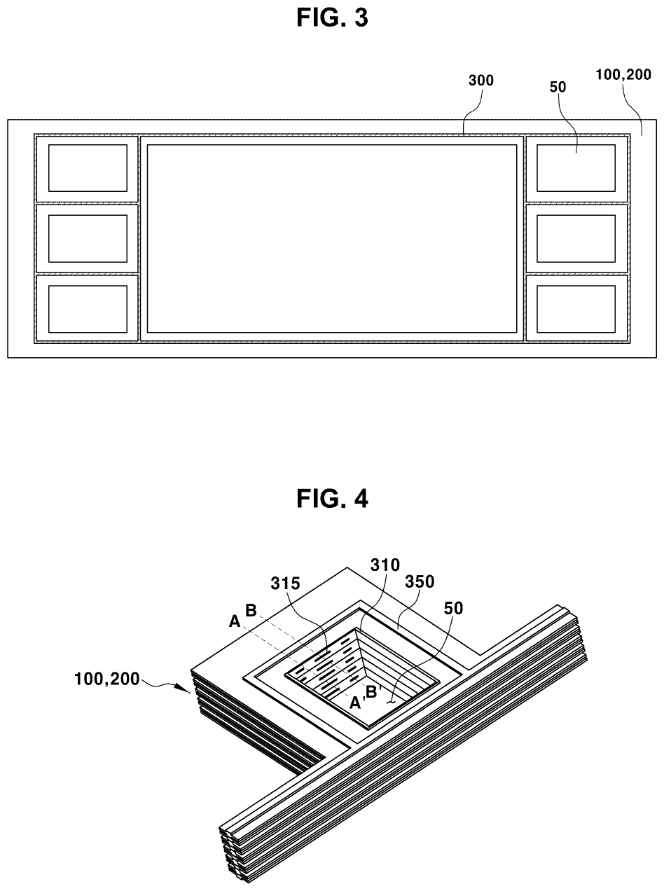

FIG. 3 is a view illustrating a separator according to an exemplary embodiment of the present disclosure.

Referring to FIG. 3, a fuel cell stack may include a plurality of unit cells. Each of the unit cells may include a pair of gas diffusion layers (GDLs) arranged on a membrane-electrode assembly (MEA), a pair of separators 100 and 200 arranged on the pair of GDLs, and a gasket structure 300 arranged on the pair of separators 100 and 200.

The pair of separators 100 and 200 may include a first separator 100 and a second separator 200. For example, the first separator 100 and the second separator 200 may each be either a cathode separator arranged at a cathode side or an anode separator arranged at an anode side. Through the first separator 100 and the second separator 200, hydrogen and air, which are reactive gases, may be introduced into the fuel cell stack, and as electricity is generated by an electrochemical reaction in the MEA, water (hereinafter “produced water”) may be generated as a by-product. Each of the pair of separators 100 and 200 may have a reactive surface along which reactive gas flows and a cooling surface along which cooling water flows.

The fuel cell stack is supplied with hydrogen and air, which are reactive gases, as well as cooling water for cooling. Here, the reactive gas and cooling water may be introduced into and discharged from the fuel cell stack through at least one manifold 50 formed in the separators 100 and 200.

The first separator 100 and the second separator 200 are bonded to each other to be integrated into one unit so that the manifolds therein may link up with each other, and the first separator 100 and the second separator 200 may have shapes similar to each other so that the reactive areas in the manifolds are aligned in the same position. The reactive area in the manifolds 50 in the first separator 100 and the second separator 200 is a space where reactive gas or cooling water is introduced into or discharged out, or flows, and the gasket structure 300 may be arranged along the perimeter of the reactive area in the manifolds 50 to create an airtight line for airtightness.

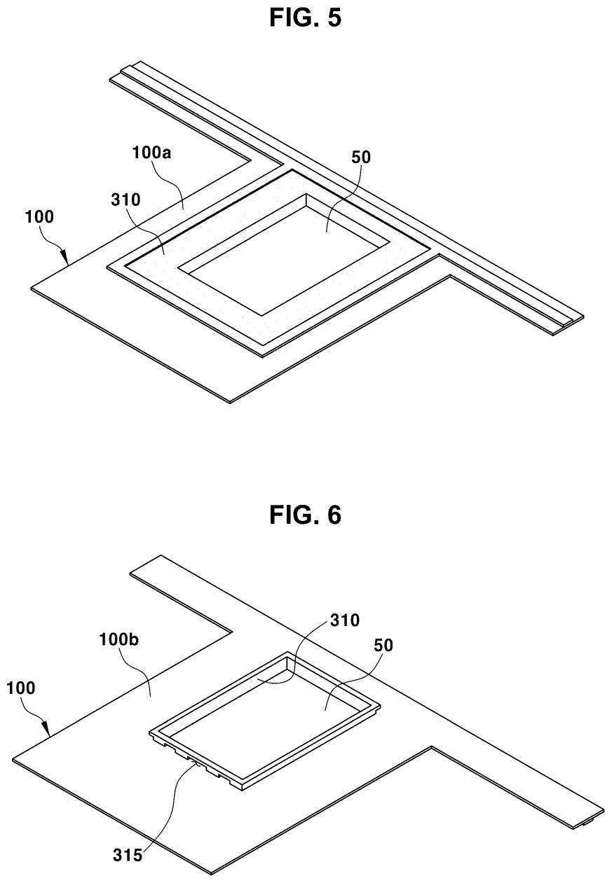

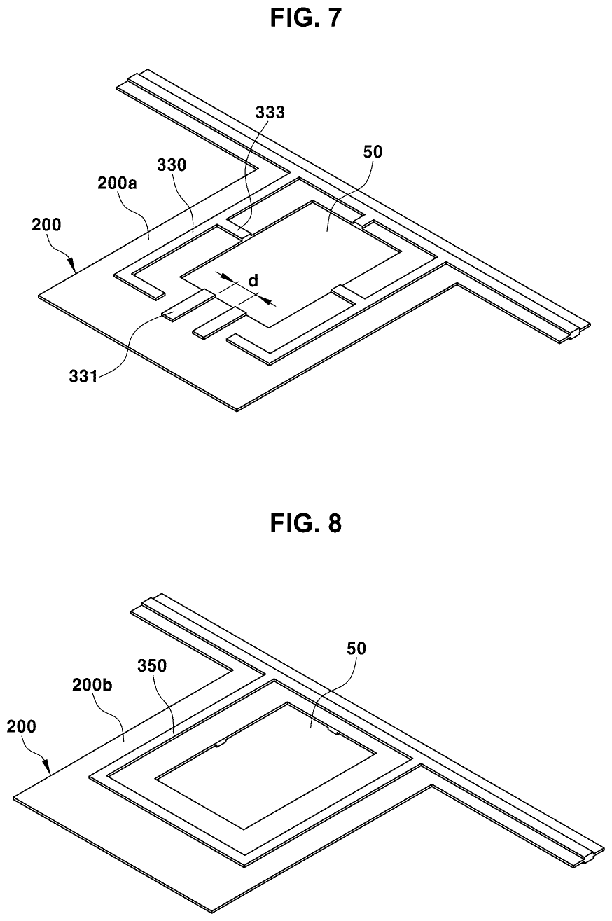

FIG. 4 is a view illustrating a separator assembly according to one exemplary embodiment of the present disclosure, FIG. 5 is a view illustrating a first surface of a first separator according to one exemplary embodiment of the present disclosure, FIG. 6 is a view illustrating a second surface of the first separator according to one exemplary embodiment of the present disclosure, FIG. 7 is a view illustrating a third surface of a second separator according to one exemplary embodiment of the present disclosure, and FIG. 8 is a view illustrating a fourth surface of the second separator according to one exemplary embodiment of the present disclosure. FIG. 4 through FIG. 8 are views to explain a gasket structure in any one manifold among a plurality of manifolds. FIG. 5 through FIG. 8 are views to explain a state before the first gasket of the first separator and the second separator are coupled to each other.

Referring to FIG. 4 through FIG. 8, a separator assembly may include a first separator 100, a second separator 200, and gasket structures 310, 330, and 350. The first separator 100 and the second separator 200 may have at least one manifold 50 through which reactive gas or cooling water flows. In an example, the first separator 100 may be an anode separator, and the second separator 200 may be a cathode separator. In another example, the first separator 100 may be a cathode separator, and the second separator 200 may be an anode separator. The first separator 100 may include a first surface 100a and a second surface 100b, and the second separator 200 may include a third surface 200a and a fourth surface 200b. In an example, the second surface 100b and the third surface 200a may be cooling surfaces, and the first surface 100a and the fourth surface 200b may be reactive surfaces. In a case where the second surface 100b and the third surface 200a are cooling surfaces, cooling water may flow between the second surface 100b and the third surface 200a. In another example, the second surface 100b and the third surface 200a may be reactive surfaces, and the first surface 100a and the fourth surface 200b may be cooling surfaces. In a case where the second surface 100b and the third surface 200a are reactive surfaces, reactive gas may flow between the second surface 100b and the third surface 200a.

The gasket structures 310, 330, and 350 may be arranged on the first surface 100a of the first separator 100, on the third surface 200a of the second separator 200, and on the fourth surface 200b of the second separator 200, respectively. Specifically, a first gasket 310 may be arranged on the first surface 100a of the first separator 100, a second gasket 330 may be arranged on the third surface 200a of the second separator 200, and a third gasket 350 may be arranged on the fourth surface 200b of the second separator 200. The first gasket 310 may extend from the first surface 100a of the first separator 100 to the fourth surface 200b of the second separator 200, and the first gasket 310 may surround the edge of the first separator 100 and the edge of the second separator 200. The edges of the first separator 100 and second separator 200 may be the ends of the first separator 100 and second separator 200 exposed by the at least one manifold 50. The first gasket 310 may surround the edges of the first separator 100 and second separator 200 so that the edges of the first separator 100 and second separator 200 are not exposed by the at least one manifold 50. Moreover, the first gasket 310 may be arranged to contact all of the first surface 100a of the first separator 100, the fourth surface 200b of the second separator 200, the edge of the first separator 100, and the edge of the second separator 200. The first gasket 310 may contact the entire edges of the first separator 100 and second separator 200.

The first gasket 310 may be arranged on the first surface 100a of the first separator 100 while surrounding the edge of at least one manifold 50. Moreover, the first gasket 310 may be arranged on the fourth surface 200b of the second separator 200 while surrounding the edge of the at least one manifold 50. One end of the first gasket 310 may be arranged on the first surface 100a of the first separator 100, and another end of the first gasket 310 may be arranged on the fourth surface 200b of the second separator 200. The first gasket 310 may extend in a direction from the first surface 100a toward the second surface 100b. Because the first gasket 310 is made of an elastic material, in a process of stacking the second separator 200 on the first separator 100, the first gasket 310 may be bent in a direction toward the at least one manifold 50 and then return to the original position thereof. Accordingly, the second separator 200 may be fixed on the first separator 100 by the other end of the first gasket 310.

The first gasket 310 may include a slit 315 configured to allow reactive gas or cooling water to flow between the second surface 100b and the third surface 200a or to discharge reactive gas or cooling water between the second surface 100b and the third surface 200a. The slit 315 may be an area open in a direction from the at least one manifold 50 toward a reactive area in the first separator 100. The slit 315 may be provided in plurality in the first gasket 310.

The second gasket 330 may be arranged on the third surface 200a of the second separator 200 while surrounding the edge of the at least one manifold 50. The second gasket 330 may have an open area at one side thereof to allow reactive gas or cooling water to flow to the at least one manifold 50. The second gasket 330 may include guide portions 331 arranged at the open area and configured to distribute reactive gas or cooling water, and at least one protrusion 333 protruding toward the at least one manifold 50.

The guide portions 331 may be arranged at the open area of the second gasket 330. The guide portions 331 each may have a bar shape extending from the at least one manifold 50 toward the reactive area in the first separator 100. Two neighboring guide portions 331 may be spaced apart from each other by a first distance d. The position of the slit 315 may be determined to allow reactive gas or cooling water to be introduced into a space between the two neighboring guide portions 335. An open space between the guide portions 331 may align with the slit 315. For example, the slit 315 aligning with the space between the two guide portions 331 may have a width smaller than the first distance d. Moreover, space at exterior opposite sides of the two guide portions 331 may also align with the slit 315. In other words, the plurality of slits 315 may align with the open area of the second gasket 330.

The protrusion 333 may be a portion protruding toward the at least one manifold 50 from the second gasket 330 arranged to surround the at least one manifold 50. The protrusion 333 may be provided in plurality. For example, the protrusions 333 may protrude toward three sides out of the four sides of the at least one manifold 50 that is open in a square shape, wherein the three sides exclude a side adjacent to the guide portions 331.

The third gasket 350 may be arranged on the fourth surface 200b of the second separator 200 while surrounding the edge of the at least one manifold 50. FIG. 8 is a view illustrating a state before the first gasket 310 and the second separator 200 are coupled to each other. However, when the first gasket 310 and the second separator 200 are coupled to each other, the other end of the first gasket 310 may be arranged on the fourth surface 200b of the second separator 200.

According to an exemplary embodiment of the present disclosure, the edge of the first separator 100 and the edge of the second separator 200 exposed by the at least one manifold 50 may be covered by the first gasket 310 extending from the first surface 100a of the first separator 100 to the fourth surface 200b of the second separator 200. With the structure of the first gasket 310, the edge of the first separator 100 and the edge of the second separator 200 that are not coated may be prevented from being corroded.

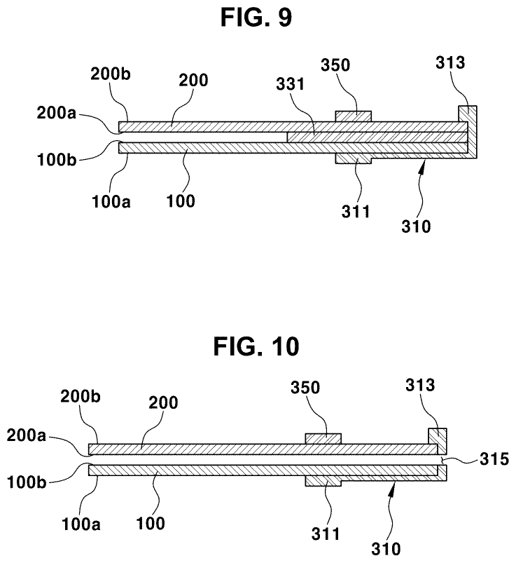

FIG. 9 is a cross-sectional view taken along line A-A′ in FIG. 4.

Referring to FIGS. 4, 7, and 9, the first gasket 310 may be arranged on the first surface 100a of the first separator 100. The first gasket 310 may include one end 311 arranged on the first surface 100a, and another end 313 arranged on the fourth surface 200b of the second separator 200. A portion of the first gasket 310 connecting the one end 311 to the other end 313 may surround and come into direct contact with the edge of the first separator 100 and the edge of the second separator 200.

The guide portions 331 of the second gasket 330 may be arranged on the second surface 100b of the first separator 100, and the second separator 200 may be arranged on the second gasket 330 or on the guide portion 331. In other words, the second gasket 330 may be arranged on the third surface 200a of the second separator 200, and the third gasket 350 may be arranged on the fourth surface 200b of the second separator 200. The guide portion 331 may extend from the at least one manifold 50 toward the reactive area in the first separator 100 or toward the reactive area in the second separator 200 by being arranged between the second surface 100b of the first separator 100 and the third surface 200a of the second separator 200. One end of the guide portion 331 adjacent to the at least one manifold 50 may be in contact with the first gasket 310. So as to form at least one manifold 50 in each of the first separator 100 and the second separator 200, a trimming process to cut out a portion of the first separator 100 and a portion of the second separator 200 may be performed. Accordingly, the one end of the guide portion 331 may be arranged at a side same as the sides of the first separator 100 and second separator 200 exposed by the at least one manifold 50. However, there may be created an empty space between the one end of the guide portion 331, adjacent to the at least one manifold 50, and the first gasket 310.

Except for some areas open through the slit 315, the first gasket 310 may cover the edge of the first separator 100 and the edge of the second separator 200. The first gasket 310 extends to connect the first surface 100a to the fourth surface 200b, and the cross-section of the first gasket 310 may have a “U” shape. Owing to the cross-sectional shape of the first gasket 310, the coupling force between the first separator 100 and the second separator 200 may also increase.

In an example, the first gasket 310 may be injected through a mold so that the cross-section thereof has a “U” shape. The second separator 200 is stacked toward the first gasket 310, which has elasticity, so as to be fit in a space between the first separator 100 and the first gasket 310.

In another example, the first gasket 310 may be injected into a plate shape and arranged on the first surface 100a. The shape of the first gasket 310 may allow the other end 313 of the first gasket 310 to be arranged on the fourth surface 200b of the second separator 200 after the second separator 200 is stacked on the first separator 100.

FIG. 10 is a cross-sectional view taken along line B-B′ in FIG. 4. For brevity of explanation, the feature described above with reference to FIG. 9 is not repeated.

Referring to FIG. 4 and FIG. 10, reactive gas or cooling water may flow through the slit 315 formed in the first gasket 310. A space between the second surface 100b of the first separator 100 and the third surface 200a of the second separator 200 may be exposed through the slit 315. However, the first gasket 310 comes into direct contact with the edge of the first separator 100 and with the edge of the second separator 200, and areas other than the edge of the first separator 100 and the edge of the second separator 200 are coated or surface treated with a material such as titanium Ti, which has high corrosion resistance, to prevent corrosion. Therefore, even when the space between the second surface 100b of the first separator 100 and the third surface 200a of the second separator 200 is exposed, the edge of the first separator 100 and the edge of the second separator 200 are not exposed, thus decreasing the possibility of corrosion of the first separator 100 and second separator 200.

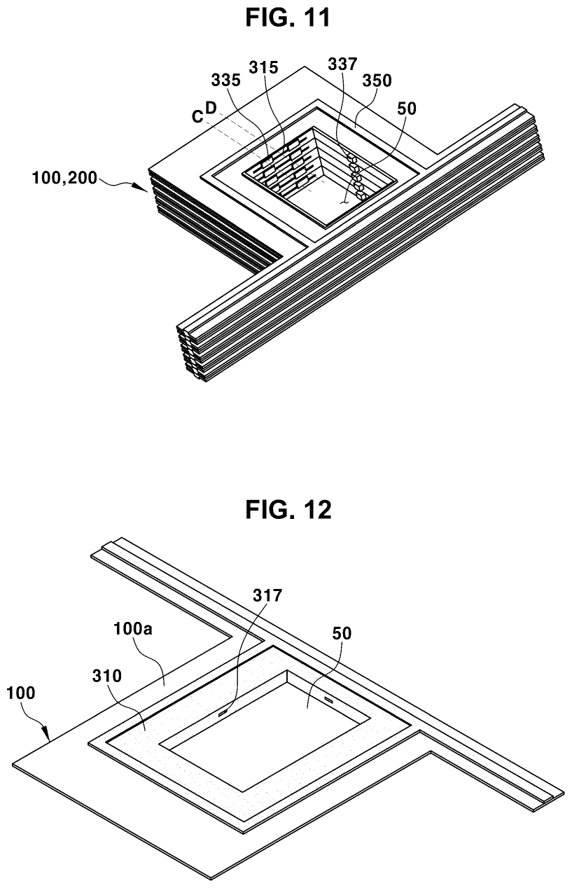

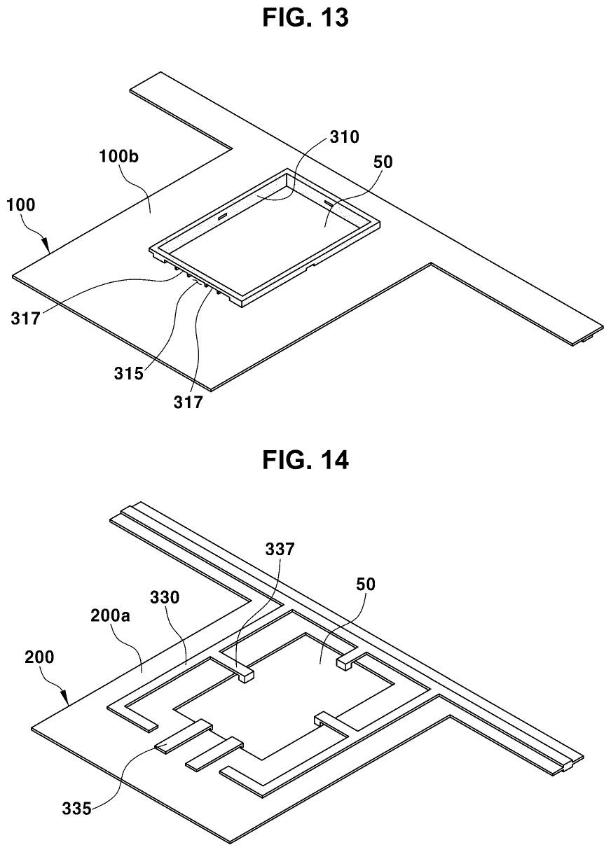

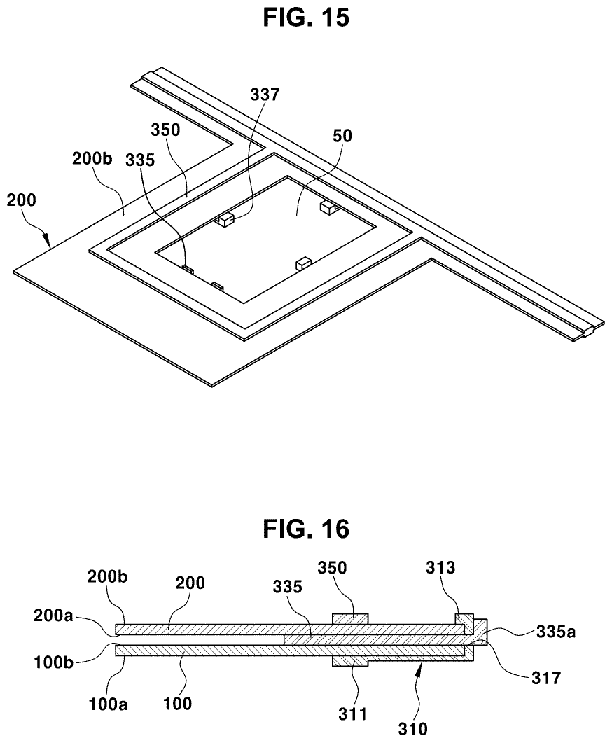

FIG. 11 is a view illustrating a separator assembly according to a different exemplary embodiment of the present disclosure, FIG. 12 is a view illustrating a first surface of a first separator according to a different exemplary embodiment of the present disclosure, FIG. 13 is a view illustrating a second surface of a first separator according to a different exemplary embodiment of the present disclosure, FIG. 14 is a view illustrating a third surface of a second separator according to a different exemplary embodiment of the present disclosure, and FIG. 15 is a view illustrating a fourth surface of a second separator according to a different exemplary embodiment of the present disclosure. FIG. 11 through FIG. 15 are views to explain a gasket structure with respect to any one manifold among the plurality of manifolds. FIG. 12 through FIG. 15 are views illustrating a state before the first gasket of the first separator and the second separator are coupled to each other.

Referring to FIGS. 11 through 15, a separator assembly may include a first separator 100, a second separator 200, and gasket structures 310, 330, and 350. The first separator 100 and the second separator 200 may have at least one manifold 50 through which reactive gas or cooling water flows.

The gasket structures 310, 330, and 350 may include a first gasket 310, a second gasket 330, and a third gasket 350. Specifically, the first gasket 310 may be arranged on a first surface 100a of the first separator 100, the second gasket 330 may be arranged on a third surface 200a of the second separator 200, and the third gasket 350 may be arranged on a fourth surface 200b of the second separator 200. The first gasket 310 may extend from the first surface 100a of the first separator 100 to the fourth surface 200b of the second separator 200, and the first gasket 310 may surround the edge of the first separator 100 and the edge of the second separator 200. The edge of the first separator 100 and the edge of the second separator 200 may be an end of the first separator 100 and an end of the second separator 200, which are exposed by the at least one manifold 50. In other words, the first gasket 310 may surround the edge of the first separator 100 and the edge of the second separator 200 so that the edge of the first separator 100 and the edge of the second separator 200 are not exposed by the at least one manifold 50.

The first gasket 310 may be arranged on the first surface 100a of the first separator 100 while surrounding the edge of at least one manifold 50. Moreover, the first gasket 310 may be arranged on the fourth surface 200b of the second separator 200 while surrounding the edge of the at least one manifold 50. One end of the first gasket 310 may be arranged on the first surface 100a of the first separator 100, and another end of the first gasket 310 may be arranged on the fourth surface 200b of the second separator 200. The first gasket 310 may extend in a direction from the first surface 100a toward the second surface 100b.

The first gasket 310 may include a 315 configured to allow reactive gas or cooling water to flow between the second surface 100b and the third surface 200a or to discharge reactive gas or cooling water through a space between the second surface 100b and the third surface 200a. The slit 315 may be an area open in a direction from the at least one manifold 50 toward a reactive area in the first separator 100. The slit 315 may be provided in plurality in the first gasket 310.

The first gasket 310 may include through holes 317 into which one end of guide portion 335 and one end of protrusion 337 of the second gasket 330 to be described later are inserted. The through holes 317 may be formed in some portions of the first gasket 310 extending in a direction from the first separator 100 toward the second separator 200. In other words, the through holes 317 each may be formed in a corresponding one of the four sides of the first gasket 310 extending from the first separator 100 toward the second separator 200. At one side of the first gasket 310 in a direction from the at least one manifold 50 toward the reactive area in the first separator 100, the slit 315 and the through holes 317 may all be formed. The slit 315 may be provided between two through holes 317 adjacent to each other. Moreover, the slit 315 may be provided in plurality. The slits 315 may be provided between two neighboring through holes 317 and at exterior opposite sides of the two neighboring through holes 317.

The second gasket 330 may be arranged on the third surface 200a of the second separator 200 while surrounding the edge of the at least one manifold 50. The second gasket 330 may have an open area at one side thereof to allow reactive gas or cooling water to flow to the at least one manifold 50. The second gasket 330 may include guide portions 335, arranged at the open area and configured to distribute reactive gas or cooling water, and at least one protrusion 337, protruding toward the at least one manifold 50.

The guide portions 335 may be arranged at the open area of the second gasket 330. The guide portions 335 each may have a bar shape extending from the at least one manifold 50 toward the reactive area in the first separator 100. The position of the slit 315 may be determined to allow reactive gas or cooling water to be introduced into a space between two guide portions 335 adjacent to each other. An open space between the guide portions 335 may align with the slit 315. Moreover, space at exterior opposite sides of the two guide portions 335 may also align with the slit 315. In other words, the plurality of slits 315 may align with the open area of the second gasket 330.

The protrusion 337 may be a portion protruding toward the at least one manifold 50 from the second gasket 330 arranged to surround the at least one manifold 50. The protrusion 337 may be provided in plurality. For example, the protrusions 337 may protrude toward three sides out of the four sides of the at least one manifold 50 that is open in a square shape, wherein the three sides exclude a side adjacent to the guide portions 335.

One end of each of the guide portions 335 and protrusions 337 may protrude toward the at least one manifold 50 in a direction perpendicular to a direction in which the first separator 100 and the second separator 200 are stacked. In other words, the guide portions 335 and the protrusions 337 may overlap the at least one manifold 50 in the direction in which the first separator 100 and the second separator 200 are stacked.

The third gasket 350 may be arranged on the fourth surface 200b of the second separator 200 while surrounding the edge of the at least one manifold 50. FIG. 8 is a view illustrating a state before the first gasket 310 and the second separator 200 are coupled to each other. When the first gasket 310 and the second separator 200 are coupled to each other, the other end of the first gasket 310 may be arranged on the fourth surface 200b of the second separator 200.

According to an exemplary embodiment of the present disclosure, by coupling the guide portions 335 and protrusions 337 of the second gasket 330 protruding toward the at least one manifold 50 into the through holes 317 provided in the first gasket 310, the coupling force between the first separator 100 and the second separator 200 may be increased.

FIG. 16 is a cross-sectional view taken along line C-C′ in FIG. 11.

Referring to FIGS. 11, 14, and 16, the first gasket 310 may be arranged on the first surface 100a of the first separator 100. The first gasket 310 may include one end 311 arranged on the first surface 100a, and another end 313 arranged on the fourth surface 200b of the second separator 200. A portion of the first gasket 310 connecting the one end 311 to the other end 313 may surround the edge of the first separator 100 and the edge of the second separator 200.

The guide portions 335 of the second gasket 330 may be arranged on the second surface 100b of the first separator 100, and the second separator 200 may be arranged on the second gasket 330 or on the guide portion 335. In other words, the second gasket 330 may be arranged on the third surface 200a of the second separator 200, and the third gasket 350 may be arranged on the fourth surface 200b of the second separator 200.

The first gasket 310 may include a through hole 317 through which one end 335a of the guide portion 335 of the second gasket 330 passes. The one end 335a of the guide portion 335 may be a portion that extends between the first separator 100 and the second separator 200 to protrude through the through hole 317. The one end 335a of the guide portion 335 may extend in the direction in which the first separator 100 and the second separator 200 are stacked. In other words, the guide portion 335 may extend between the first separator 100 and the second separator 200, and then the one end 335a, which is an end of the guide portion 335, may bend in the direction in which the first separator 100 and the second separator 200 are stacked.

The first gasket 310 extends to connect the first surface 100a to the fourth surface 200b, and the cross-section of the first gasket 310 may have a “U” shape. Owing to the cross-sectional shape of the first gasket 310, the coupling force between the first separator 100 and the second separator 200 may also increase.

In an example, the first gasket 310 may be injected through a mold so that the cross-section thereof has a “U” shape. The second separator 200 is stacked toward the first gasket 310, which has elasticity, so as to be fit in a space between the first separator 100 and the first gasket 310.

In another example, the first gasket 310 may be injected into a plate shape and arranged on the first surface 100a. The first gasket 310 may be fabricated to allow the other end 313 of the first gasket 310 to be arranged on the fourth surface 200b of the second separator 200 after the second separator 200 is stacked on the first separator 100.

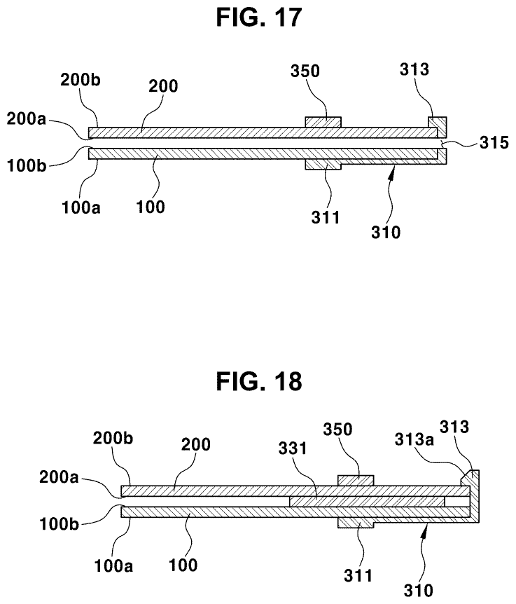

FIG. 17 is a cross-sectional view taken along line D-D′ in FIG. 11.

Referring to FIG. 11 and FIG. 17, reactive gas or cooling water may flow through the slit 315 formed in the first gasket 310. A space between the second surface 100b of the first separator 100 and the third surface 200a of the second separator 200 may be exposed through the slit 315. However, the first gasket 310 comes into direct contact with the edge of the first separator 100 and with the edge of the second separator 200, and areas other than the edge of the first separator 100 and the edge of the second separator 200 are coated or surface treated with a material such as titanium Ti, which has high corrosion resistance, to prevent corrosion. Therefore, even when the space between the second surface 100b of the first separator 100 and the third surface 200a of the second separator 200 is exposed, the edge of the first separator 100 and the edge of the second separator 200 are not exposed, thus decreasing the possibility of corrosion of the first separator 100 and second separator 200.

The slit 315 formed in the first gasket 310 may not overlap the through hole 317 illustrated in FIG. 16. The slit 315 and the through hole 317 may be formed in one side of the first gasket 310 in a direction from the at least one manifold 50 toward the reactive area in the first separator 100. However, the slit 315 and the through hole 317 may be spaced apart from each other and may have different functions. The slit 315 may serve as a passage through which reactive gas or cooling water flows, and the through hole 317 may serve to connect the first gasket 310 and the second gasket 330 to each other to increase the coupling force between the first separator 100 and the second separator 200.

FIG. 18 is a cross-sectional view of a separator assembly according to a further different exemplary embodiment of the present disclosure.

Referring to FIG. 4 and FIG. 18, the first gasket 310 may extend from the first surface 100a of the first separator 100 to the fourth surface 200b of the second separator 200. An edge of the other end 313 of the first gasket 310 arranged on the fourth surface 200b of the second separator 200 may be chamfered. Because the other end 313 of the first gasket 310 is arranged to surround the at least one manifold 50, the edge of the other end 313 of the first gasket 310 subject to chamfering may be four surfaces of the other end 313. Chamfering may be cutting the edge of the other end 313 of the first gasket 310 at an angle. One surface of the other end 313 of the first gasket 310 chamfered may be called an inclined surface 313a. The inclined surface 313a may extend obliquely toward the fourth surface 200b of the second separator 200, and the further the inclined surface 313a extends toward the fourth surface 200b of the second separator 200, the farther away from the at least one manifold 50.

The second separator 200 may be stacked on the first separator 100 after placing the first gasket 310 on the first surface 100a of the first separator 100. In the process of stacking the second separator 200, a force is applied to the second separator 200 in a direction toward the first separator 100, and thus the other end 313 of the first gasket 310 may be bent toward the at least one manifold 50. Because the first gasket 310 is made of an elastic material, the other end 313 of the first gasket 310 may return to the original position or original shape thereof when the second separator 200 is arranged on the first separator 100. Here, the other end 313 of the first gasket 310 may be a hindrance when stacking the second separator 200 on the first separator 100, but the inclined surface 313a may alleviate such process problems.

According to an exemplary embodiment of the present disclosure, the inclined surface 313a is formed in a direction away from the fourth surface 200b of the second separator 200, and the width of the other end 313 of the first gasket 310 decreases as the inclined surface 313a is formed. The inclined surface 313a allows the second separator 200 to be easily stacked on the first separator 100 in the process of stacking the second separator 200 on the first separator 100.

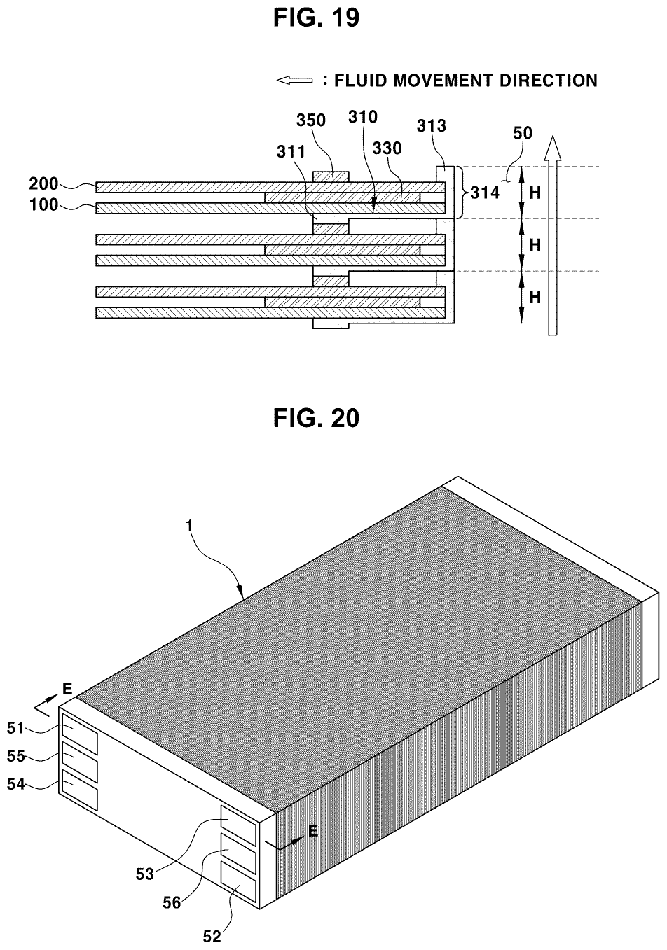

FIG. 19 is a cross-sectional view illustrating the direction in which a first gasket of a separator assembly is arranged with respect to the fluid movement direction according to the present disclosure.

Referring to FIG. 4 and FIG. 19, directions of reactive gas or cooling water flowing through a plurality of manifolds 50 may not uniform. The arrangement direction of the first gasket 310 may vary depending on a direction in which a fluid including reactive gas or cooling water moves.

The first gasket 310 may extend from the first surface 100a of the first separator 100 to the fourth surface 200b of the second separator 200, and the second separator 200 may be fixed on the first separator 100 by the other end 313 of the first gasket 310. However, when a fluid moves from the fourth surface 200b of the second separator 200 in contact with the first gasket 310 toward the first surface 100a of the first separator 100, the coupling force between the first separator 100 and the second separator 200 generated by the other end 313 of the first gasket 310 may decrease. Accordingly, reactive gas or cooling water flowing through the at least one manifold 50 may move in a direction from the first surface 100a in contact with the first gasket 310 toward the fourth surface 200b in contact with the first gasket 310. In other words, the direction from the one end 311 of the first gasket 310 toward the other end 313 of the first gasket 310 may coincide with the fluid movement direction. The other end 313 of the first gasket 310 may be arranged on a surface same as the surface on which the third gasket 350 is arranged.

A portion of the first gasket 310 extending in a direction coincide with the fluid movement direction may be called an extension 314. The extension 314 is a portion to cover the edge of the first separator 100 and the edge of the second separator 200, and may be a portion not in contact with either of the first surface 100a and the fourth surface 200b. Moreover, the extension 314 may be a portion of the first gasket 310 extending in a vertical direction in the drawing, and a portion of the extension 314 may overlap the other end 313. With respect to the direction in which the first separator 100 and the second separator 200 are stacked, the extending length of the extension 314 may be a first length H. The first length H may be equal to the sum of the height of the one end 311 of the first gasket 310, the height of the second gasket 330, the height of the third gasket 350, the height of the first separator 100, and the height of the second separator 200, with respect to the direction in which the first separator 100 and the second separator 200 are stacked. In other words, the first length H may be equal to the height of one separator assembly.

According to an exemplary embodiment of the present disclosure, the direction of the other end 313 arranged relative to the extension 314 of the first gasket 310 coincides with the fluid movement direction, thereby reducing the possibility in which the coupling force between the first separator 100 and the second separator 200 created by the other end 313 of the first gasket 310 is weakened due to a movement of fluid.

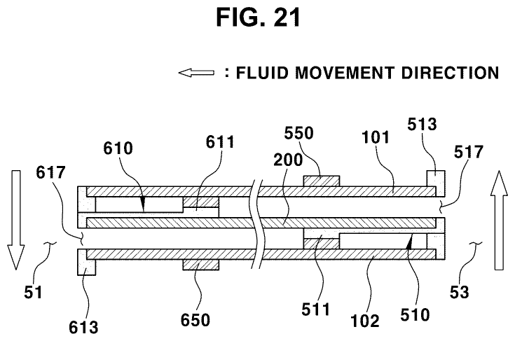

FIG. 20 is a view illustrating a fuel cell stack according to an exemplary embodiment of the present disclosure, and FIG. 21 is a cross-sectional view taken along line E-E′ in FIG. 20.

Referring to FIG. 20 and FIG. 21, a fuel cell stack 1 may be manufactured by stacking a plurality of separator assemblies. The fuel cell stack 1 may have a plurality of manifolds 51, 52, 53, 54, 55, and 56 through which reactive gas or cooling water is introduced and discharged.

The manifolds 51, 52, 53, 54, 55, and 56 may include inlet manifolds 51 and 54 through which reactive gas is introduced, outlet manifolds 52 and 53 through which reactive gas is discharged, and cooling water manifolds 55 and 56 through which cooling water is introduced and discharged. The inlet manifolds 51 and 54 may include a first inlet manifold 51 through which oxygen is introduced, and a second inlet manifold 54 through which hydrogen is introduced. The outlet manifolds 52 and 53 may include a first outlet manifold 52 through which oxygen is discharged and a second outlet manifold 53 through which hydrogen is discharged. The cooling water manifolds 55 and 56 may include a cooling water inlet manifold 55 through which cooling water is introduced and a cooling water outlet manifold 56 through which cooling water is discharged. However, the direction in which the reactive gas and cooling water is introduced or discharged may vary by a designer.

The arrangement direction of gasket structures 510 and 610 according to an exemplary embodiment of the present disclosure may change depending on the fluid movement direction. The gasket structures 510 and 610 may include a first gasket structure 510 arranged on at least one first manifold through which reactive gas or cooling water flows and a second gasket structure 610 arranged on at least one second manifold through which reactive gas or cooling water flows. The at least one first manifold and the at least one second manifold may be different from each other in terms of the fluid movement direction. In other words, the flow direction of the reactive gas or cooling water flowing in the at least one first manifold may be different from the flow direction of the reactive gas or cooling water flowing in the at least one second manifold. In this exemplary embodiment, the at least one first manifold may include the first outlet manifold 52, the second outlet manifold 53, and the cooling water outlet manifold 56, and the at least one second manifold may include the first inlet manifold 51, the second inlet manifold 54, and the cooling water inlet manifold 55.

The first gasket structure 510 may surround the edge of any one separator 101 of first separators 101 and 102 exposed by the at least one first manifold and the edge of the second separator 200. The second gasket structure 610 may surround the edge of the other one separator 102 of the first separators 101 and 102 exposed by the at least one second manifold and the edge of the second separator 200. Here, the arrangement direction of the first gasket structure 510 and the arrangement direction of the second gasket structure 610 may differ from each other with respect to the fluid movement direction, and a separator in contact with the first gasket structure 510 and a separator in contact with the second gasket structure 610 may differ from each other. In other words, the first gasket structure 510 and the second gasket structure 610 both may be in contact with the second separator 200, and the any one separator 101 of the first separators 101 and 102 in contact with the first gasket structure 510 and the other one separator 102 of the first separators 101 and 102 in contact with the second gasket structure 610 may differ from each other.

The first gasket structure 510 may have one end 511 arranged to overlap, with respect to a direction where the separators are stacked, a third gasket structure 550 arranged on the any one separator 101, and another end 513 facing the one end 511. The other end 513 of the first gasket structure 510 may not overlap the third gasket structure 550 with respect to the direction where the separators are stacked. A portion of the first gasket structure 510 connecting the one end 511 to the other end 513 may surround the edge of the any one separator 101 and the edge of the second separator 200. The one end 511 of the first gasket structure 510 may be arranged on the second separator 200, and the other end 513 of the first gasket structure 510 may be arranged on the any one separator 101. A flow direction of reactive gas or cooling water flowing through at least one first manifold 53 may be a direction from one surface of the second separator 200 in contact with the one end 511 of the first gasket structure 510 toward one surface of the any one separator 101 in contact with the other end 513 of the first gasket structure 510. In other words, the flow direction of the reactive gas or cooling water flowing through the at least one first manifold 53 may be a direction from the second separator 200 toward the any one separator 101.

The second gasket structure 610 may have one end 611 arranged to overlap, with respect to a direction where the separators are stacked, a fourth gasket structure 650 arranged on the other one separator 102, and another end 613 facing the one end 611. The other end 613 of the second gasket structure 610 may not overlap the fourth gasket structure 650 with respect to the direction where the separators are stacked. A portion of the second gasket structure 610 connecting the one end 611 to the other end 613 may surround the edge of the other one separator 102 and the edge of the second separator 200. The one end 611 of the second gasket structure 610 may be arranged on the second separator 200, and the other end 613 of the second gasket structure 610 may be arranged on the other one separator 102. A flow direction of reactive gas or cooling water flowing through tat least one second manifold 51 may be a direction from one surface of the second separator 200 in contact with the one end 611 of the second gasket structure 610 toward one surface of the other one separator 102 in contact with the other end 613 of the second gasket structure 610. In other words, the flow direction of the reactive gas or cooling water flowing through the at least one second manifold 51 may be a direction from the second separator 200 toward the other one separator 102.

As is apparent from the above description, the present disclosure provides the following effects.

According to an exemplary embodiment of the present disclosure, the edge of a first separator and the edge of a second separator exposed by at least one manifold may be covered by a first gasket extending from a first surface of the first separator to a fourth surface of the second separator. With the structure of the first gasket, the edge of the first separator and the edge of the second separator that are not coated may be prevented from being corroded.

According to an exemplary embodiment of the present disclosure, owing to the cross-sectional shape of the first gasket, the coupling force between the first separator and the second separator may also increase.

According to an exemplary embodiment of the present disclosure, although the space between a second surface of the first separator and a third surface of the second separator is open to be exposed to allow cooling water or reactive gas to flow therethrough, the edge of the first separator and the edge of the second separator are covered by the first gasket, reducing the possibility of corrosion of the first separator and the second separator.

According to an exemplary embodiment of the present disclosure, the direction of the other end of the first gasket arranged relative to the extension of the first gasket coincides with the fluid movement direction, thereby reducing the possibility in which the coupling force between the first separator and the second separator created by the other end of the first gasket is weakened due to movement of fluid.

In the above, embodiments of the present disclosure have been described with reference to the accompanying drawings. However, those skilled in the art to which the present disclosure pertains will understand that the present disclosure may be embodied in other specific forms without changing the technical idea or essential features thereof. Therefore, it should be understood that the embodiments described above are illustrative in all respects and not restrictive.

1. A separator assembly to prevent corrosion of a separator edge, the separator assembly comprising:
a first separator having a first surface and a second surface;
a first gasket positioned on the first surface; and
a second separator having a third surface and a fourth surface, and having at least one manifold through which reactive gas or cooling water flows;
wherein the first gasket connects the first surface to the fourth surface to surround an edge of the first separator and an edge of the second separator exposed by the least one manifold.

2. The separator assembly according to claim 1,
wherein the second surface and the third surface are arranged to face each other, and
wherein the first gasket includes a slit configured to allow reactive gas or cooling water to flow between the second surface and the third surface, or to discharge reactive gas or cooling water between the second surface and the third surface.

3. The separator assembly according to claim 2,
wherein, on the third surface of the second separator, a second gasket is arranged along a perimeter of the at least one manifold, and
wherein the second gasket has an open area at one side to allow reactive gas or cooling water to flow to the at least one manifold.

4. The separator assembly according to claim 3, wherein the second gasket comprises guide portions arranged at the open area, the guide portions being configured to distribute reactive gas or cooling water.

5. The separator assembly according to claim 4, wherein each of the guide portions have an open space in between that aligns with the slit.

6. The separator assembly according to claim 1,
wherein, on the third surface of the second separator, a second gasket is arranged along a perimeter of the at least one manifold, and
wherein the second gasket comprises at least one protrusion protruding toward the at least one manifold, and guide portions configured to distribute reactive gas or cooling water.

7. The separator assembly according to claim 6, wherein the at least one protrusion and the guide portions each have one end protruding toward the at least one manifold in a direction perpendicular to a direction in which the first separator and the second separator are stacked.

8. The separator assembly according to claim 7, wherein the first gasket includes through holes, and wherein the one end of each of the at least one protrusion and the guide portions is inserted into a corresponding one of the through holes.

9. The separator assembly according to claim 8, wherein the first gasket includes a slit configured to allow reactive gas or cooling water to flow through, and positioned between the through holes into each of which one end of the guide portion is inserted.

10. The separator assembly according to claim 1, wherein the first gasket is arranged along a perimeter of the at least one manifold on the first surface of the first separator and on the fourth surface of the second separator.

11. The separator assembly according to claim 10, wherein the first gasket is contacts each of the first surface, the fourth surface, the edge of the first separator, and the edge of the second separator.

12. The separator assembly according to claim 1, wherein the first gasket arranged on the fourth surface of the second separator has one end, and an edge of the one end is chamfered.

13. The separator assembly according to claim 1,
wherein, on the third surface of the second separator, a second gasket is arranged along a perimeter of the at least one manifold,
wherein, on the fourth surface of the second separator, a third gasket is arranged along a perimeter of the at least one manifold, and
wherein the first gasket includes one end arranged on the fourth surface and an other end arranged at a position overlapping the third gasket with respect to a stacking direction from the first separator to the second separator.

14. The separator assembly according to claim 13, wherein a portion of the first gasket connecting the one end to the other end surrounds the edge of the first separator and the edge of the second separator.

15. A fuel cell stack comprising:
a plurality of first separators;
a plurality of second separators; and
a gasket structure arranged on the plurality of first separators and the plurality of second separators;
wherein the plurality of first separators and the plurality of second separators each have at least one first manifold and at least one second manifold through which reactive gas or cooling water flows; and
wherein the gasket structure comprises a first gasket structure surrounding edges of one of the plurality of first separators and one of the plurality of second separators exposed by the at least one first manifold, and a second gasket structure surrounding edges of one of the plurality of first separators and one of the plurality of second separators exposed by the at least one second manifold.

16. The fuel cell stack according to claim 15, wherein a flow direction of reactive gas or cooling water flowing through the at least one first manifold is different from a flow direction of reactive gas or cooling water flowing through the at least one second manifold.

17. The fuel cell stack according to claim 15,
wherein the first gasket structure and the second gasket structure both are in contact with the second separator, and
wherein any one separator of the plurality of first separators in contact with the first gasket structure in contact with the second gasket structure is different from the other one separator of the plurality of first separators in contact with the second gasket structure.

18. The fuel cell stack according to claim 17,
wherein the first gasket structure has a first end overlapping a third gasket structure arranged on the any one separator, and a second end facing the first end;
wherein the first end of the first gasket structure is arranged on each of the plurality of second separators, and the second end of the first gasket structure is arranged on the any one separator; and
wherein a flow direction of reactive gas or cooling water flowing through the at least one first manifold is a direction from one surface of the second separator in contact with the first end of the first gasket structure toward one surface of the any one separator in contact with the second end of the first gasket structure.

19. The fuel cell stack according to claim 18,
wherein the second gasket structure has a first end overlapping a fourth gasket structure arranged on the other one separator and a second end facing the first end;
wherein the first end of the second gasket structure is arranged on the second separator, and the second end of the second gasket structure is arranged on the other one separator; and
wherein a flow direction of reactive gas or cooling water flowing through the at least one second manifold is a direction from one surface of the second separator in contact with the first end of the second gasket structure toward one surface of the other one separator in contact with the second end of the second gasket structure.

20. The fuel cell stack according to claim 19,
wherein the first gasket structure includes a first slit configured to allow reactive gas or cooling water to flow through the at least one first manifold, and through a space between the second separator and the any one separator, and
wherein the second gasket structure includes a second slit configured to allow reactive gas or cooling water to flow through the at least one first manifold and through a space between the second separator and the other one separator.
